(19) United States
(12) Patent Application Publication
(10) Pub. No.: US 2003/0162572 A1
(43) Pub. Date: Aug. 28, 2003

(54) Information system methods and apparatus

(76) Inventor: Kenneth W. Winters, Renton, WA (US)

Correspondence Address: HEWLETT-PACKARD COMPANY, Intellectual Property Administration, P.O. Box 272400, Fort Collins, CO, 80527-2400, US

(21) Appl. No.: 10/087,149

(22) Filed: Feb. 27, 2002

(51) Int. Cl. H04B 1/38

(52) U.S. Cl. 455/569; 455/563

(57) ABSTRACT

Apparatus and methods of information management in conjunction with the operation of a vehicle are disclosed. The information system apparatus and methods in accordance with the instant invention provide a substantially hands-free environment to a vehicle operator with regard to managing information pertaining to the operation of the vehicle. The apparatus and methods in accordance with the instant invention provide means of initiating communications, processing data, storing data, retrieving data, and using data to manage vehicle functions and operations.

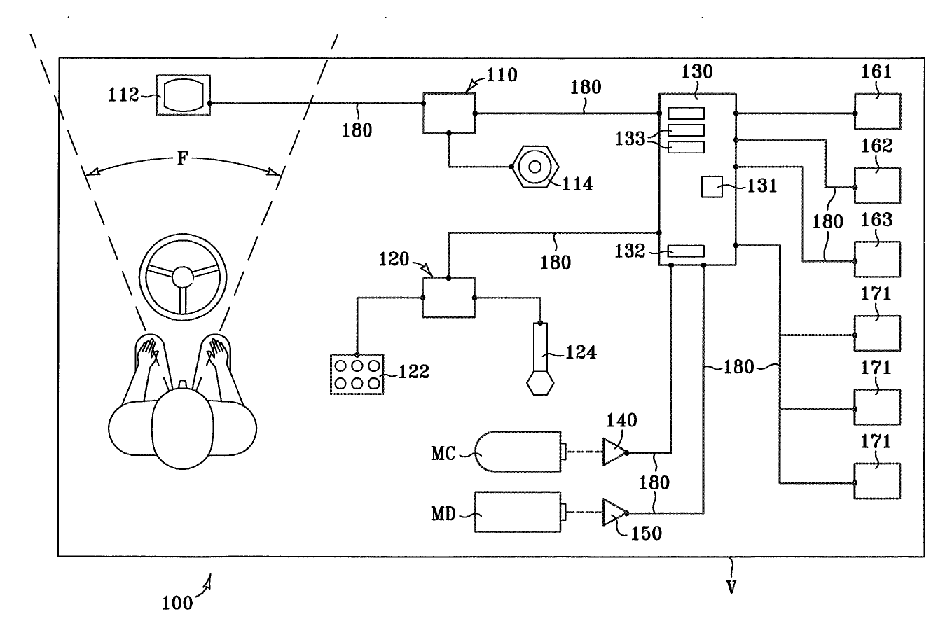

### FIELD OF THE INVENTION

The invention claimed and disclosed herein pertains to information systems, and more specifically to information systems used in conjunction with the operation of vehicles.

### BACKGROUND OF THE INVENTION

Various methods and apparatus are known in the prior art for managing information in a mobile environment. The management of information can include processing, storing, and communicating information. Mobile telephones, pagers and the like are known in the prior art and are used for communicating information. Likewise, various forms of information storage and processing devices and means are known in the prior art, including mobile “laptop” computers, personal digital assistants, and various other devices that have data processing and/or data storage capability.

Additionally, various prior art data management devices and means are incorporated into larger systems and apparatus in order to manage information in conjunction with the operation of such systems and apparatus. For example, various prior art devices and means, such as microprocessors, and various computer executable instructions (“programs”) are used, for example, are often integrated into, and used in conjunction with the operation of, automotive vehicles, aircraft, and water borne vessels. That is, many prior art vehicles of various types are equipped with microprocessors or the like which are employed for processing data in conjunction with the operational and functional aspects of the vehicle.

Additionally, individuals are oftentimes required to operate a vehicle in addition to managing various information related to travel. This information can include, for example, trip schedules, itineraries, routes, appointments, and the like. The individuals who manage this type of information include service personnel who travel frequently from jobsite to jobsite, as well as delivery and transport drivers, sales agents, inspectors, pilots, boat captains, and emergency service personnel such as ambulance drivers and rescue personnel. These individuals also often require frequent communications with base stations or other mobile personnel while operating a vehicle.

These individuals often need to retrieve or access various data in order to perform more efficiently. For example, an ambulance driver can perform more efficiently if driving directions are accessible in real time while en route. Similarly, delivery drivers and service personnel can perform more efficiently if itineraries and appointment schedules are available in real time and while en route.

However, operation and use of prior art information management devices and methods often require a level of attentiveness which precludes the simultaneous operation of a vehicle in a safe and/or efficient manner. Additionally, prior art information management devices and methods fail to provide an integrated means of managing a broad array of information. To the contrary, prior art information systems often require a plurality of diverse devices and methods which can lead to a stratified and inefficient system for the management of information in a mobile environment. What is needed then are information system methods and apparatus which achieve the benefits to be derived from similar prior art methods and/or devices, but which avoid the shortcomings and detriments individually associated therewith.

### SUMMARY OF THE INVENTION

The instant invention provides for processing, communicating, storing, and otherwise managing information in conjunction with the operation of a vehicle in a mobile environment. Apparatus and methods in accordance with the instant invention provide an integrated information management platform that can be employed by the operator of a vehicle to facilitate the efficient operation of the vehicle as well as various subsystems and peripheral systems thereof. The integrated information management platform provided by the apparatus and methods of the instant invention can also be employed by the vehicle operator to fulfill various communication requirements relating to the operations and functions of the vehicle in a mobile environment.

These and other aspects and embodiments of the present invention will now be described in detail with reference to the accompanying drawings, wherein:

### DESCRIPTION OF THE DRAWINGS

The accompanying FIGURE is a schematic diagram that depicts an information system in accordance with one embodiment of the instant invention.

### DETAILED DESCRIPTION OF THE INVENTION

Apparatus and methods in accordance with the instant invention bring together, in a novel way, various prior art devices and methods to form an integrated information management and communication platform. This platform can be employed by the operator of a vehicle to provide efficient management of information relating to communications as well as vehicle operational functions, trip scheduling, and routing of the vehicle. In accordance with one embodiment of the instant invention, an information system includes a controller that is communicably linked with an input device and an output device. Information such as commands and various other data can be received into the controller from the operator of a vehicle by way of the input device. Similarly, information can be presented to the operator from the controller by way of the output device. The information system is configured to provide a substantially hands-free/eyes-free operation with respect to the information system itself, wherein distraction of the operator due to operation of the information system is minimized. This is beneficial in allowing the operator to devote a substantial level of concentration to the operation of the vehicle, thus promoting more efficient and safe operation thereof.

Turning to The accompanying FIGURE, a schematic diagram is shown which depicts an information system 100 in accordance with one embodiment of the instant invention. The information system 100 can be used in conjunction with a vehicle “V.” The term “vehicle” as used herein means any device or contrivance for carrying or conveying persons or objects, including land conveyances, water-borne vessels, and aircraft. For example, the vehicle “V” can be a motor vehicle such as an automobile, cargo truck, passenger bus, or the like. The vehicle “V” is configured to be operated by an operator “O.” In the case wherein the vehicle “V” is a motor vehicle, the operator “O” can be described in common terminology as a “driver.” Likewise, for example, in the case wherein the vehicle is an aircraft, the operator can be described as a “pilot.” The vehicle “V” can be included as part of the information system 100. That is, the information system 100 can comprise the vehicle “V.”

At a minimum, however, the information system 100 comprises an output device 110, an input device 120, and a controller 130. The output device 110 is supported on the vehicle “V” and is configured to present information to the operator “O.” Similarly, the input device 120 is also supported on the vehicle “V” and is configured to receive information from the operator “O.” The term “information” as used herein means any data that can be stored in or processed by a digital processing device such as a computer or the like. The input device 120 is preferably configured to generate and transmit data signals in response to, and indicative of, information input thereto, wherein the data signals are transmitted to the controller 130.

The controller 130 is also supported on the vehicle “V” and is configured to receive information in the form of data signals transmitted from the input device 120. The controller 130 is also configured to transmit information in the form of data signals to the output device 110. The output device 110 is preferably configured to receive data signals indicative of information, wherein the information is presented to the operator “O” in response to receipt, by the output device, of the data signals transmitted thereto from the controller 130. The controller 130 is also preferably configured to process data in various manners as will be discussed below in further detail.

The information system 100 preferably includes a data storage memory device 131 in which information in the form of data can be retrievably stored. The memory device 131 is preferably resident within the controller 130 as shown. The memory device 131 can be, for example, a digital memory chip, a hard drive, or the like. The controller 130 preferably includes a speech recognition program (software) 132 stored therein. Speech-recognition programs and software are known in the art and are generally configured to convert vocal speech data signals into data signals which are recognizable by various data processing programs and the like. That is, speech-recognition software can be employed to convert human speech into commands and the like which are recognizable by digital processing devices and such. Uses of the speech recognition program 132 with respect to the instant invention will be discussed below in greater detail.

The information system 100 can also include a set of computer-executable instructions 133 which are preferably resident within the controller 130 as shown. The computer-executable instructions 133 can be configured in any of a number of known manners and are preferably configured to perform various functions and operations associated with the operation of the information system 100, wherein such functions and operations include routing data signals, performing various calculations and algorithms, storing and retrieving data, and the like. The relevance of the computer-executable instructions 133 will become apparent in later discussion. Furthermore, computer-executable instructions, including the development and implementation thereof for specific uses and functions, as well as the related hardware required for the use thereof, are well-understood in the art and shall therefore be discussed herein only in basic, general terms.

The information system 100 preferably comprises an on-board local network 180 which is supported on the vehicle “V.” The network 180 is configured to communicably link the controller 130 with the output device 110 and with the input device 120. That is, the network 180 provides a means of conveying or transmitting data signals between the controller 130 and the output device 110, and between the controller and the input device 120. The network 180 can also be configured to communicably link other optional components of the information system 100 as will be explained below in further detail.

The network 180 can comprise any of a number of known devices, and can employ any of a number of known methods and means, for communicably linking two or more objects or devices. For example, the network 180 can employ hard wiring and/or fiber optic filaments as a means of conveying data signals. Alternatively, or in addition, the network 180 can employ wireless means of data signal transmission, including such means as short-range radio wave transmission, infrared transmission, and the like. Furthermore, the network 180 can be configured to employ any of a number of known signal transmission protocols, such as analog and/or digital signal transmission, as well as various known signal routing means and devices.

The output device 110, which is mentioned above, can comprise a visual display device 112. The visual display device 112 is configured to visually present information to the operator “O.” The visual display device 112 can be an integral portion of the output device 110. Alternatively, as shown in The accompanying FIGURE, the visual display device 112 can be separate component that is communicably linked with the output device 110 by a portion of the network 180, wherein data signals can be transmitted to the visual display device from the controller 130 or the like. The visual display device 112 is preferably located within the field of view “F” of the operator “O.” For example, the visual display device 112 is preferably located on the dashboard (not shown) or the like of the vehicle “V.” Such a location of the visual display device 112 can promote the efficient and safe operation of the vehicle “V” by minimizing distraction of the operator “O.”

The visual display device 112 can comprise, for example, a heads up display, which is commonly referred to as a “HUD.” Heads up displays are known and employed in several areas of the prior art, and particularly in fighter jets. The heads up display allows information to be visually presented to the operator “O” without substantially impeding the ability of the operator to operate the vehicle “V.” Heads up displays are generally configured to visually present information by displaying the information on or near the windscreen or windshield (not shown) of the vehicle “V” so that the displayed information can be easily perceived by the operator “O” in conjunction with the operation of the vehicle.

For example, a visual display device 112 that comprises a heads up display can be particularly beneficial in presenting vision-enhancement information to the operator “O” during, and in conjunction with, the operation of the vehicle “V.” Vision-enhancement information can include guidance information or information pertaining to potential hazards during conditions of limited or decreased visibility (such as fog or night time driving conditions). Specifically, a vision-enhancement system (discussed further below) can be employed in conjunction with a heads up display in order to display objects or hazards which lay in the path of the vehicle “V” and which would normally not be visible or identifiable by the operator “O.” Alternatively, or in addition, the visual display device 112 can comprise other known forms and/or configurations of visual displays such as liquid crystal display screens, light emitting diode digital read outs, cathode ray tube display screens, as well as analog and digital gauges, and the like.

As is indicated by the accompanying FIGURE, the output device 110 can comprises an audio device 114 which is configured to audibly present information to the operator “O.”The audio device 114 can be integral with the display device 110. Alternatively, the audio device can be a separate component that is communicably linked with the display device 110 by way of a portion of the network 180 as shown. That is, when the display device 110 and the audio device 114 are communicably linked by way of the network 180, data signals can be transmitted to the audio device 114 from the controller 130 or the like. The audio device 114 can be, for example, an audio speaker. Furthermore, the audio device 114 can comprise at least a portion of a sound system (not shown) or the like, with which the vehicle “V” is supplied.

As mentioned above, the system 100 comprises an input device 120 that is communicably linked with the controller 130. The input device 120 is configured to receive information from the operator “O.” That is, the operator “O” can input information into the input device 120. The information input by the operator into the input device 120 can then be transmitted as data signals to the controller 130 by way of the network 180. As shown in the accompanying FIGURE, the input device 120 can comprise a touch pad 122. The touch pad 122 can be integral with the input device 120. Alternatively, the touch pad 122 can be a separate component that is communicably linked with the input device 120 as shown.

The touch pad 122 can be manipulated by the operator “O” so as to input information into the input device 120. The touch pad 122 can be configured in any of a number of known manners such as that of a keypad. For example, in the case wherein the touch pad 122 is configured as a keypad, the operator “O” can type information on the keypad so as to input the information into the input device 120. It is understood that the touch pad 122 can be configured in any of a number of alternative manners in addition to that of a keypad.

For example, the touch pad 122 can be configured as a lever commonly referred to as a “joystick” (not shown). Such a joystick can be manipulated by the operator “O” by moving the joystick in one of a number of different directions or to one of number of different positions which each correspond to respective processes, commands, operations, or the like with respect to the operation of the information system 100. The joystick can include various buttons, triggers, or the like (not shown), the movement of which can be associated with respective processes, commands, operations, or the like with respect to the operation of the information system 100.

Alternatively, or in addition, the input device 120 can comprise a microphone 124. The microphone 124 can be integral with the input device 120. Alternatively, the microphone 124 can be a separate component that is communicably linked with the input device 120 as shown. The term “microphone” as used herein means any device that is configured to receive sound waves and convert the sound waves into a data signal that can be transmitted to another device. The microphone 124 is configured to enable the operator “O” to input information into the input device 120 by speaking. That is, the microphone 124 is configured to receive vocal information from the operator “O.” Thus, the operator “O” can input information into the input device 120 by way of manipulation of the touch pad 122 and/or by speaking into the microphone 124.

As a study of The accompanying FIGURE reveals, the information system 100 can comprise a mobile communication device interface 140 which is supported on the vehicle “V” and which is communicably linked with the controller 130 by way of at least a portion of the network 180. The mobile communication device interface 140 is configured to temporarily communicably link a mobile communication device “MC” device to the controller 130. That is, the mobile communication device interface 140 is configured to facilitate the transmission of data signals between the mobile communication device “MC” and the controller 130. The mobile communication device “MC” is a mobile device that provides communication services and can include, for example, a mobile telephone such as a cellular phone, a pager, or the like.

The transmission of data signals between the mobile communication device “MC” and the controller 130 can allow the mobile communication device to be operated by way of the controller. For example, in the case wherein the mobile communication device “MC” is a cellular phone, the controller 130 can be configured to dial, and/or answer, the cellular phone by way of the mobile communication device interface 140. Likewise, in the case wherein the mobile communication device “MC” is a pager, the pager can relay an incoming text message to the controller 130 by way of the mobile communication device interface 140.

A further study of the accompanying FIGURE reveals that the information system 100 can comprise a mobile data processing/storage device interface 150. The mobile data processing/storage device interface 150 is supported on the vehicle “V” and is communicably linked with the controller 130 by way of at least a portion of the network 180. The mobile data processing/storage device interface 150 is configured to temporarily communicably link a mobile data processing/storage device “MD” device to the controller 130. That is, the mobile data processing/storage device interface 150 is configured to facilitate the transmission of data signals between the mobile data processing/storage device “MD” and the controller 130. The mobile data processing/storage device “MD” is a mobile device that provides data processing and/or data storage services and can include, for example, a mobile computer such as a laptop computer, a personal digital assistant, or the like.

The transmission of data signals between the mobile data processing/storage device “MD” and the controller 130 can allow the mobile data processing/storage device to be operated by way of the controller. For example, in the case wherein the mobile data processing/storage device “MD” is a laptop computer, the controller 130 can be configured to access data within the laptop, and/or cause the laptop to process data. That is, the controller 130 is preferably configured to transmit instructions to the data processing/storage device “MD” by way of the mobile data processing/storage device interface 150. Similarly, the mobile data processing/storage device “MD” preferably can send data to the controller by way of the mobile data processing/storage device interface 150.

Both the mobile communication device interface 140 and the mobile data processing/storage device interface 150 can incorporate any of a number of known means of temporarily connecting two devices for data signal transmission there between. For example, either, or both, of the mobile communication device interface 140 and/or the mobile data processing/storage device interface 150 can comprise a hard wire connector (not shown). Alternatively, wireless means such as infrared data signal transmission, or short-range radio wave transmission can be employed. As yet a further alternative, either, or both, of the mobile communication device interface 140 and/or the mobile data processing/storage device interface 150, can employ sound wave transmission means.

The information system 100 can be configured to temporarily communicably link with standard mobile communication devices “MC” and/or standard mobile data processing/storage devices “MD.” Alternatively, or in addition, the information system 100 can be configured to temporarily link with mobile communication devices “MC” and/or mobile data processing/storage devices “MD” which have been modified for the purpose of temporarily communicably linking with the respective interface 140 and 150.

The information system 100 can comprise any of a number of additional subsystems such as a vision-enhancement system 161. The vision-enhancement system is preferably supported on the vehicle “V” and is communicably linked with the controller 130 by way of at least a portion of the network 180 as is shown. The vision-enhancement system 161 is configured to operably communicate with the controller 130. That is, the data signals can be transmitted between the controller 130 and the vision-enhancement system 161, wherein such transmission of data signals facilitates the function and operation of the vision-enhancement system.

The vision-enhancement system 161 is configured to enhance the vision of the operator “O” during operation of the vehicle “V” under conditions of reduced or limited visibility. Such conditions can include, for example, darkness, fog, rain, smoke, and the like. The vision-enhancement system 161 can include any of a number of known vision-enhancement means such as infrared imaging, RADAR, sound waves, and the like.

The information system 100 can also comprise a navigation system 162 that is preferably supported on the vehicle “V” and communicably linked with the controller 130 by way of at least a portion of the network 180 as shown. The navigation system 162 is configured to assist the operator “O” with navigational and/or directional finding functions during operation of the vehicle “V.” The navigational system 162 is configured to operably communicate with the controller 130, wherein data signals can be transmitted between the controller 130 and the navigation system 162, wherein such transmission of data signals facilitates the function and operation of the navigation system. It is understood that the navigation system 162 can comprise various known navigation and direction-finding means such as global positioning system (“GPS”) technology.

The information system 100 can also comprise an auxiliary subsystem 163. The auxiliary subsystem 163 can be configured in the manner of any of a number of known auxiliary subsystems employed for use with vehicles. The auxiliary subsystem 163 is communicably linked with the controller 130 as shown, wherein data signals can be transmitted there between. The auxiliary subsystem 163 can comprise, for example, a weather band radio receiver that is configured to receive weather band radio signals. The weather band radio signals that are received by such a weather band radio receiver can be transmitted to the controller 130 for further processing and/or storage thereof, and the like.

The auxiliary subsystem 163 can alternatively be a data receiver that is configured to receive, store, and/or process data that is transmitted to the receiver from a remote transmitter (not shown). Alternatively, or in addition, the auxiliary subsystem 163 can be a data transmitter that is configured to transmit data signals to a remote receiver (not shown). Various means of transmitting and receiving data are known in the art including means of transmitting and receiving data via satellite communications systems.

The information system 100 can include any number of known peripheral systems 171. The peripheral system 171 is a system that is related to the function or operation of the vehicle “V.” The peripheral system 171 can include such systems as an operational lighting system (turn signal indicators, headlights, auxiliary lights, interior lights), a windshield wiper system, a vehicle sound system, a vehicle climate control system, a vehicle motive power plant, an auxiliary power system, a vehicle motive power transmission, a vehicle drive train, a vehicle suspension system, a vehicle control system (flight controls, steering controls, braking controls, throttle controls), a power traction system, an entrance/egress system, a load control system, a fuel level detection system, a lubrication level detection system, and the like. The peripheral system 171 is communicably linked with the controller 130 by way of at least a portion of the network 180, wherein data signals can be transmitted between the controller and the respective peripheral system. That is, the controller 130 is configured to operate the respective peripheral system 171.

In operation, the information system 100 can be advantageously employed by the operator “O” to facilitate efficient operation of the vehicle “V” as will now be discussed in conjunction with various illustrative examples. Generally, the information system 100 can enable the operator “O” to communicate with other individuals and devices while allowing the operator to concentrate more fully on the operation of the vehicle “V.” Additionally, the information system 100 can enable the operator “O” to access, store, and process various information and data while concentrating more fully on the operation of the vehicle “V.” Furthermore, the information system 100 can be utilized by the operator “O” to operate the vehicle “V” and its related components and systems in a more efficient manner. It is understood that the following discussion is intended to provide illustrative examples of some of the possible uses and configurations of the information system 100 in accordance with the instant invention. Thus, the specific illustrative examples provided herein are not intended to limit the use and/or scope of the information system 100.

The information system 100 can be employed by the operator “O” to communicate with other individuals or devices (not shown) while the operator is operating the vehicle “V.”0 The operator “O” preferably establishes a connection between the mobile communication device “MC” and the mobile communication device interface 140 prior to the commencement of the operation of the vehicle “V.” Likewise, the operator “O” preferably establishes a connection between the mobile data processing/storage device “MD” and the mobile data processing/storage device interface 150 prior to the commencement of the operation of the vehicle “V.”

The operator “O” can efficiently establish communications with another individual or device (not shown). In the case wherein the mobile communication device “MC” is a cellular telephone, the operator “O” can initiate a call by inputting the appropriate instruction into the input device 120. For example, the operator “O” can manipulate the touch pad 122 in a unique manner that corresponds to an instruction to initiate a cellular telephone call, wherein the instruction is recognizable by the controller 130. That is, the operator “O” can depress a unique key or combination of keys on the touch pad 122 which correspond to a recognizable instruction. Alternatively, the operator “O” can speak a vocal command into the microphone 124, wherein the vocal command corresponds to a recognizable instruction to initiate a cellular telephone. That is, when the operator “O” speaks a vocal command into the microphone 124, data signals are preferable transmitted from the microphone 124 to the controller 130 whereupon the speech-recognition program 132 converts the vocal commands into data signals that are recognizable by, for example, the computer-executable instructions 133.

The computer-executable instructions 133 are preferably configured so as to respond to the operator's command to initiate a telephone call. The computer-executable instructions 133 preferably perform the required steps to communicate with the mobile communication device “MC,” by way of the network 180 and respective interface 140, and to prepare it to make a telephone call. The operator “O” can also input a telephone number into the input device 120, such as by manipulating the touch pad or by speaking into the microphone 124. The computer-executable instructions 133 can then receive the telephone number data from the input device 120 and perform the necessary processes whereby the desired telephone number is dialed by the mobile communication device “MC.”

If the operator “O” does not know the desired telephone number, for example, a database can be automatically accessed in order to retrieve the desired telephone number in conjunction with initiating the telephone call. For example, if the operator “O” knows the name of the individual or device to which the telephone call is to be made, the operator can speak the name of the individual or device into the microphone 124. The microphone 124 can then send the name in the form of data signals to the controller 130 where upon the speech recognition program 132 converts the vocalized name into data signals that are recognizable by the computer-executable steps 133.

In the case wherein the desired telephone number and associated name are stored within the mobile data processing/storage device “MD,” for example, the computer-executable steps 133 can then communicate with the mobile data processing/storage device by way of the network 180 and respective interface 150 to retrieve the desired telephone number. When the desired telephone number is located within the mobile data processing/storage device “MD” and transmitted to the controller 130, the computer-executable instructions 133 can then transmit the desired telephone number to the mobile communication device “MC” and instruct the device to place the desired call.

When the communications connection is established with the desired individual or device, the operator “O” can then speak into the microphone 124 or directly into the mobile communication device “MC” for the purposes of communicating with the desired individual or device. When the telephone call is completed, the operator “O” can audibly instruct the controller 130 to end the call, whereupon the computer-executable instructions carry out the necessary procedures to end the call. The telephone call, from initiation to completion, can be performed without requiring the operator “O” to shift his/her attention to the mobile communication device “MC” or any other device. That is, the operator “O” can place a complete telephone call while focusing his/her attention on the operation of the vehicle “V.”

Alternatively, for example, the operator can send an alphanumeric message to a pager (not shown) or the like by way of the information system 100. For example, in the case wherein the auxiliary system 163 is a transmitter, the operator “O” can instruct the controller to prepare to send a pager message. The operator “O” can, for example, first speak the name of the individual or device to which the pager message is to be sent, as described above. The controller 130 can then retrieve and/or store the pager number associated with the name in preparation for sending the pager message.

The operator “O” can then vocally dictate the pager message into the microphone 124 whereupon the vocal message is converted to textual data signals by the speech-recognition program 132 and stored within the data storage memory 131 in preparation for sending the pager message. Upon completion of the dictation of the pager message, the operator “O” can instruct the information system 100 to send the pager message whereupon the message is sent by way of the auxiliary system device transmitter 163. Alternatively, the pager message can be sent in similar fashion by way of the mobile communication device “MC” in the case wherein the device is a cellular telephone, for example.

Likewise, the information system 100 can preferably receive and present incoming pager messages to the operator “O.” For example, in the case wherein the mobile communication device “MC” is a pager, an incoming message can be received thereby and transmitted by way of the respective interface 140 to the controller 130. The controller 130 can receive the incoming pager message from the mobile communication device interface 140 and can cause the message to be presented to the operator “O” by visually displaying the message on the visual display 112.

This enables the operator “O” to receive incoming pager messages while concentrating on the operation of the vehicle. The operator “O” can then instruct the controller, by way of the input device 120, to save or delete specific incoming pager messages. The controller 130 can then cause the respective pager messages to be deleted or stored either within the mobile communication device “MC,” within the mobile data processing/storage device “MD,” or within the data storage memory device 131.

The information system 100 can be employed by the operator “O” to establish scheduling and routing of the vehicle “V” in accordance with various scheduling and routing criteria. For example, the vehicle “V” can be a service or delivery vehicle that is tasked with making stops at various destinations within a given region in accordance with various time constraints and other factors. These factors can include, for example, road conditions, traffic patterns, weather, and destination access availability, among others. In such a case, the computer-executable steps 133 can be configured to determine the routing of the vehicle in accordance with factors such as those mentioned above.

In accordance with one embodiment of the information system 100, the computer-executable instructions 133 are configured to maintain an up-to-date running routing schedule which is determined by real-time data that is received from the operator “O” and/or other individuals or devices (not shown) at remote locations. Specifically, at the beginning of a vehicle trip, the operator “O” can instruct the information system 100 to present information pertaining to the first stop.

For example, the operator “O” can speak the command “PRESENT FIRST STOP” into the microphone 124, whereupon the controller 130 responds by transmitting to the output device 110 information pertaining to the first stop to be made by the operator. The output device 110 can present the pertinent information visually by way of the visual display device 112, and/or audibly by way of the audio device 114. That is, the information can be displayed as text on the visual display device 112 or broadcast audibly by way of artificial speech or the like, as well as the audio device 114.

Such information pertaining to the first stop which is presented by the output device 110 can include, for example, the address or location of the first stop, driving directions to the first stop, the nature of the stop, the projected time and duration of the stop, as well as any other pertinent information such as contact names and telephone numbers. This information pertaining to the stops can be stored as data within the data storage memory device 131 or within the mobile data processing/storage device “MD,” or the like.

Stops can be added, deleted, or otherwise altered remotely by another individual or device. For example, a vehicle dispatcher (not shown) who is responsible for establishing the vehicle stops, can be located in a remote central location. The information system 100 is preferably configured to allow the dispatcher to alter the schedule by way of remote communications without disturbing the operator “O” or otherwise distracting the attention of the operator from the operation of the vehicle “V.”

For example, the dispatcher can send data signals to the controller 130 by way of the mobile communication device “MC” or by way of the auxiliary subsystem 163, wherein the auxiliary subsystem is configured to receive data signals. Specifically, for example, the dispatcher can send data signals to the controller 130, wherein such data signals contain data indicative of various changes, additions, and/or deletions to the schedule. That is, the dispatcher can add new stops to the schedule, delete stops that have been cancelled, and/or make changes to the schedule to reflect last minute changes in the availability of cargo for pickup or the like. Such changes in the schedule can be performed remotely by the dispatcher while the vehicle “V” is in operation and without disturbing or distracting the operator “O.”

As mentioned above, the schedule can be changed and/or updated in accordance with other factors such as local weather, relative progress of the vehicle and operator, location of the vehicle, road conditions, and the like. Such changes and/or updates can be performed by the computer-executable steps 133, for example, in response to various inputs from the operator “O,” dispatcher, or other individuals or devices. For example, when a stop is added, deleted, or otherwise changed by the dispatcher, the routing directions and/or schedule can be updated in accordance with such changes and in accordance with the location of the vehicle “V” as determined by the navigation system 162. That is, the most efficient route and schedule can be determined by the computer-executable instructions 133 in response to additions, deletions, and/or changes to the stops in light of the current relative location of the vehicle “V.”

The computer-executable steps 133 are preferably configured to continually compare the progress and/or location of the vehicle “V” to the projected schedule and route so that the appropriate notification can be given in the event that a given stop might necessarily or preferably occur either later or earlier than originally anticipated. Additionally, the information system 100 is preferably configured to transmit updated current schedule and/or progress reports to the dispatcher or other individual on a regular basis. This can enable the dispatcher (not shown) to contact the various destinations in response to changes in progress of the vehicle “V.”

During a given trip, the operator “O” can instruct the information system 100 to present specific information by way of the output device 110. For example, the operator “O” can speak the command, “PRESENT NEXT STOP” to the microphone 124 of the input device 120. In response to such a command, the controller 130 can transmit data signals indicative of the next stop to the output device 110 whereupon the data is presented to the operator “O.” Additionally, for example, the operator “O” can instruct the controller 130 to present the projected time and location of the next required refueling stop.

This can preferably be performed by the controller 130 in conjunction with the peripheral system 171 in the case wherein the peripheral system is either a fuel level detection system or a fuel metering system or the like. In such a case, the peripheral system 171 can be configured either to detect the fuel level or to detect the fuel flow rate and to send data signals indicative thereof to the controller 130. The computer-executable instructions 133 can then use such data, together with the distance traveled, to project the next required refueling stop.

The information system 100 can alternatively be configured to periodically automatically notify a given vehicle destination of the progress of the vehicle “V.” That is, the navigation system 162 can provide the controller 130 with a vehicle location relative to the location of the given vehicle destination. The controller 130 can thus be configured to periodically transmit messages to the given destination in the form of pager messages, for example, which indicated the relative progress of the vehicle “V.” In this manner, the destination can efficiently plan for the arrival of the vehicle at the destination.

The information system 100 is preferably configured to allow the operator “O” to operate a given peripheral system 171 by way of the information system. For example, the operator “O” can vocally indicate to controller 130 by way of the input device 120 that the road conditions are slippery. Specifically, the operator “O” can speak the words, “SLIPPERY ROAD” into the microphone 124. The microphone 124 sends vocal data signals to the controller 130 whereupon the speech-recognition program 132 converts the vocal data signals into signals that are recognizable by the computer-executable instructions 133.

The computer-executable instructions 133 can then generate data signals which are sent to the respective peripheral devices 171 such as in the case wherein the peripheral devices include a traction control system or the like. The data signals generated by the computer-executable instructions 133 then instruct the traction control system to activate for slippery road conditions. Likewise, computer-executable instructions 133 can be configured to respond to the operator's spoken words of “SLIPPERY ROAD” by additionally activating the vehicle headlights, and the like.

Likewise the information system 100 can be configured to allow the operator “O” to operate any of the peripheral systems 171 in a manner similar to that described above. For example, in the case wherein the peripheral systems 171 include a climate control system, the operator “O” can speak the word “WARMER” so as to cause the controller 130 to respond by increasing the output temperature of the climate control system.

In accordance with another embodiment of the instant invention, a method of operating an information system includes providing a vehicle such as the vehicle “V” shown in the accompanying FIGURE and described above. The method also includes providing an information system such as the information system 100 which is also shown in the accompanying FIGURE and described above with respect thereto. The information system is supported on the vehicle. The vehicle is configured to be operated by an operator such as the operator “O” shown in the accompanying FIGURE. Information is input into the information system, for example, by the operator. This includes inputting information in the form of spoken words. In response to inputting information into the information system, information is presented. That is, when the operator inputs information into the information system, other information is presented to the operator in response to inputting information.

The method can comprise providing a mobile telephone and inputting a vocal command into the information system. The mobile telephone is automatically dialed in response to inputting the vocal command into the information system. That is, the operator can, for example, cause the mobile telephone to be dialed by inputting a vocal command into the information system. A mobile data processing/storage device can be provided in accordance with the method. The mobile data processing/storage device can be, for example, a laptop computer or the like. Preferably, data is stored on the mobile data processing/storage device. In order to retrieve the data stored on the mobile data processing/storage device, a vocal command can be input into the information system, wherein data from the device is presented in response to the vocal command. That is, the data is presented to the operator, wherein the operator can perceive the data.

The method can also comprise providing a vehicle peripheral system such as the peripheral system 171 shown in the accompanying FIGURE and described above with respect thereto. As described above, the vehicle peripheral system can be any of a number of known vehicle peripheral systems. A vocal command can be input into the information system, for example, by the operator. In response to the vocal command, the vehicle peripheral system can be operated. As a specific example, the operator can speak the phrase, “WINDSHIELD WIPERS ON,” whereupon the vehicle windshield wipers would then operate in response to the phrase spoken by the operator.

While the above invention has been described in language more or less specific as to structural and methodical features, it is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. An information system for use on a vehicle that is operated by an operator, the system comprising:
an output device which is supported on the vehicle and which is configured to present information to the operator;
an input device which is supported on the vehicle and which is configured to receive information from the operator;
a controller which is supported on the vehicle and which is configured to transmit information in the form of data signals to the output device, and which is configured to receive information in the form of data signals from the input device.

2. The information system of claim 1, wherein the output device comprises a visual display device.

3. The information system of claim 2, and wherein the visual display device is a heads up display.

4. The information system of claim 1, wherein the output device comprises an audio device.

5. The information system of claim 1, wherein the input device comprises a touch pad.

6. The information system of claim 1, wherein the input device comprises a microphone.

7. The information system of claim 1, and further comprising a mobile communication device interface which is supported on the vehicle and configured to temporarily communicably link a mobile communication device to the controller.

8. The information system of claim 1, and further comprising a mobile data processing/storage device interface which is supported on the vehicle and configured to temporarily communicably link a mobile data processing/storage device to the controller.

9. The information system of claim 1, and further comprising an operator vision-enhancement system which is supported on the vehicle and configured to communicate with the controller.

10. The information system of claim 1, and further comprising a navigation system which is supported on the vehicle and configured to communicate with the controller.

11. The information system of claim 11, and wherein the navigation system employs global positioning system technology.

12. The information system of claim 1, and further comprising a speech-recognition program which is operably stored in the controller.

13. The information system of claim 1, and further comprising a memory device which is communicably linked with the controller and configured to retrievably store data.

14. The information system of claim 1, and further comprising a weather band radio receiver which is communicably linked with the controller.

15. The information system of claim 1, and further comprising at least one peripheral system communicably linked with the controller, wherein the controller is configured to operate the respective peripheral system.

16. An information system comprising:
a vehicle configured to be operated by an operator;
an output device which is supported on the vehicle and configured to present information to the operator;
an input device which is supported on the vehicle and configured to receive information from the operator;
a controller supported on the vehicle;
an on-board local network which is supported on the vehicle and configured to communicably link the controller with the output device and with the input device; and,
wherein the controller is configured to receive information in signal format from the input device by way of the network, and is further configured to transmit information in signal format to the output device by way of the network and in response to the information received from the operator.

17. A method of operating an information system, comprising:
providing a vehicle;
providing an information system;
supporting the information system on the vehicle;
inputting information into the information system;
presenting information from the information system in response to inputting information into the system.

18. The method of claim 17, and further comprising:
providing a mobile telephone;
inputting a vocal command into the information system;
automatically dialing the mobile telephone in response to inputting the vocal command.

19. The method of claim 17, and further comprising:
providing a mobile data processing/storage device;
storing data on the mobile data processing/storage device;
inputting a vocal command into the information system;
presenting data from the mobile data processing/storage device in response to the vocal command.

20. The method of claim 17, and further comprising:
providing a vehicle peripheral system;
inputting a vocal command into the information system;
operating the vehicle peripheral system in response to the vocal command.
